(19) United States
(12) Patent Application Publication
(10) Pub. No.: US 2025/0266551 A1
(43) Pub. Date: Aug. 21, 2025

(54) POWER STORAGE DEVICE AND VEHICLE

(71) Applicant: TOYOTA JIDOSHA KABUSHIKI KAISHA, Toyota-shi (JP)

(72) Inventors: Kazuki SUGIE, Miyoshi-shi (JP); Akio MORI, Toyota-shi (JP); Yoshiro KAMO, Kanagawa-ken (JP); Takahiko NAKANO, Nagoya-shi (JP); Toshihiro SHIMONAKA, Toyota-shi (JP); Kenichi KOHASHI, Shizuoka-ken (JP); Yuki SODA, Nagoya-shi (JP)

(73) Assignee: TOYOTA JIDOSHA KABUSHIKI KAISHA, Toyota-shi (JP)

(21) Appl. No.: 19/010,752

(22) Filed: Jan. 6, 2025

(30) Foreign Application Priority Data
Feb. 15, 2024 (JP) 2024-021248

(51) Int. Cl. H01M 50/242; B60K 1/04; H01M 50/249; H01M 50/289

(52) U.S. Cl. CPC H01M 50/242; B60K 1/04; H01M 50/249; H01M 50/289; B60K 2001/0438; H01M 2220/20

(57) ABSTRACT

A power storage device includes: a power storage module; a housing case in which an accommodating space is formed; and a restraint. The power storage module is accommodated in the accommodating space, and the housing case includes a base member, a front wall connected to the base member, and a rear wall connected to the base member and disposed spaced apart from the front wall. The front wall includes a first connecting portion connected to the base member, and a first restraining portion located spaced apart from the first connecting portion in an up-down direction. The rear wall includes a second connecting portion connected to the base member, and a second restraining portion located spaced apart from the second connecting portion in the up-down direction. The restraint is formed to restrain the first restraining portion and the second restraining portion.

### CROSS REFERENCE TO RELATED APPLICATIONS

This nonprovisional application is based on Japanese Patent Application No. 2024-021248 filed on Feb. 15, 2024 with the Japan Patent Office, the entire content of which is hereby incorporated by reference.

### BACKGROUND

The present disclosure relates to a power storage device and a vehicle.

### DESCRIPTION OF THE BACKGROUND ART

For example, Japanese Patent Laying-Open No. 2022-55798 discloses the power storage module including stacked power storage cells, and a fastener member. The fastener member includes a pair of end plates and a restraint member. The pair of end plates are disposed on opposing ends of the stacked cells in the stacking direction. The restraint member restrains the pair of end plates in the stacking direction.

A power storage device mounted on a vehicle includes a power storage module and a case. The power storage module is accommodated in the case. The power storage module includes multiple power storage cells. The power storage cells each expand by repeatedly charging and discharging power. An external force due to the expansion of the power storage cells is loaded to the case.

For example, in order to inhibit the case from being deformed by the external force applied from the power storage cells, the power storage module may be provided with the fastener member described above. However, this increases the part count of the power storage device, thereby increasing the power storage device assembly workload and the weight of the power storage device.

### SUMMARY

The present disclosure is made to solve the above problem, and an object of the present disclosure is to provide a power storage device which can restrain the stacked power storage cells in the stacking direction, while reducing the part count, and a vehicle having the power storage device mounted thereon.

A power storage device according to the present disclosure includes: a power storage module, a housing case in which an accommodating space is formed; and a restraint. The power storage module is accommodated in the accommodating space. The housing case includes: a base member; a first side wall connected to the base member; and a second side wall connected to the base member and disposed spaced apart from the first side wall. The first side wall includes: a first connecting portion connected to the base member; and a first restraining portion located spaced apart from the first connecting portion in an up-down direction. The second side wall includes: a second connecting portion connected to the base member; and a second restraining portion located spaced apart from the second connecting portion in the up-down direction. The restraint is formed to restrain the first restraining portion and the second restraining portion.

The power storage module may include a plurality of power storage cells arranged in a first direction. The plurality of power storage cells may be each formed to extend in a second direction intersecting with the first direction, and the restraint may be arranged to run through a center of the power storage cell in the second direction.

An opening open to the accommodating space may be formed in the first side wall, and a route may be formed in the first side wall and in communication with the opening. The housing case may further include a dividing wall. The accommodating space may have a first accommodating space and a second accommodating space. The dividing wall may be formed to extend in the first direction and disposed between a center of the first side wall in the second direction and a center of the second side wall in the second direction to define the first accommodating space and the second accommodating space.

The housing case may further include: a third side wall connected to the base member; a fourth side wall connected to the base member and disposed spaced apart from the third side wall in the second direction; and a dividing wall. The accommodating space may have a first accommodating space and a second accommodating space. The dividing wall may be formed to extend in the second direction and disposed between a center of the third side wall in the first direction and a center of the fourth side wall in the first direction to define the first accommodating space and the second accommodating space. The power storage module may include a plurality of power storage cells arranged in a first direction, and the plurality of power storage cells may each be formed to extend in a second direction intersecting with the first direction. The first side wall and the second side wall may be disposed spaced apart from each other in the first direction. The housing case may further include: a third side wall connected to the base member; and a fourth side wall connected to the base member and disposed spaced apart from the third side wall in the second direction. The plurality of power storage cells may each be disposed across the third side wall and the fourth side wall.

A vehicle according to the present disclosure includes: a vehicle body; and the power storage device mounted on the vehicle body. The first direction is a front-rear direction of the vehicle.

A vehicle according to the present disclosure includes: a vehicle body; and the power storage device mounted on the vehicle body. The first direction is a width direction of the vehicle.

The foregoing and other objects, features, aspects and advantages of the present disclosure will become more apparent from the following detailed description of the present disclosure when taken in conjunction with the accompanying drawings.

### BRIEF DESCRIPTION OF THE DRAWINGS

FIG. 1 is a side view schematically showing a vehicle and a power storage device according to an embodiment of the present disclosure.

FIG. 2 is a perspective view schematically showing a vehicle frame of the vehicle.

FIG. 3 is a cross-sectional view of the vehicle frame taken along a III-III cross section of FIG. 2.

FIG. 4 is a perspective view schematically showing a power storage device.

FIG. 5 is an exploded perspective view of the power storage device of FIG. 4.

FIG. 6 is a cross-sectional view of the power storage device taken along a VI-VI cross section of FIG. 4.

FIG. 7 is a cross-sectional view of the power storage device taken along a VII-VII cross section of FIG. 4.

FIG. 8 is a cross-sectional view of the power storage device taken along a VIII-VIII cross section of FIG. 4.

FIG. 9 is a perspective view schematically showing the power storage device of FIG. 4 additionally including a dividing wall.

FIG. 10 is a schematic view of a power storage device according to Variation 1 of the embodiment.

FIG. 11 is an exploded perspective view of the power storage device according to Variation 1 of the embodiment.

FIG. 12 is a cross-sectional view of the power storage device taken along an XI-XI cross section of FIG. 10.

FIG. 13 is a schematic view of a power storage device according to Variation 2 of the embodiment.

### DESCRIPTION OF THE PREFERRED EMBODIMENTS

Embodiments according to the present disclosure will be described, with reference to the accompanying drawings. Referring now to the drawings wherein like numerals are used to refer to like or corresponding members.

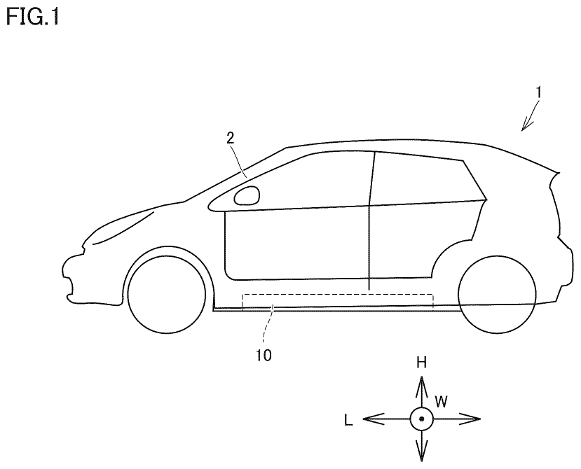

FIG. 1 is a side view schematically showing a vehicle and a power storage device according to the present embodiment. A width direction W shown in FIG. 1 indicates the width direction of the vehicle. A stacking direction L indicates the direction in which power storage cells (described below) are stacked. An up-down direction H indicates the up-down direction of the vehicle. Note that, in the present embodiment, the stacking direction L coincides with the front-rear direction of the vehicle and is one example of a “first direction” according to the present disclosure. The width direction W is one example of a “second direction” according to the present disclosure.

A vehicle 1 includes a vehicle frame 2 and a power storage device 10. The vehicle 1 is, for example, a battery electric vehicle that can be driven by a motor, or an electric-powered vehicle such as a hybrid vehicle. The vehicle 1 includes the power storage device 10 mounted underneath the vehicle 1.

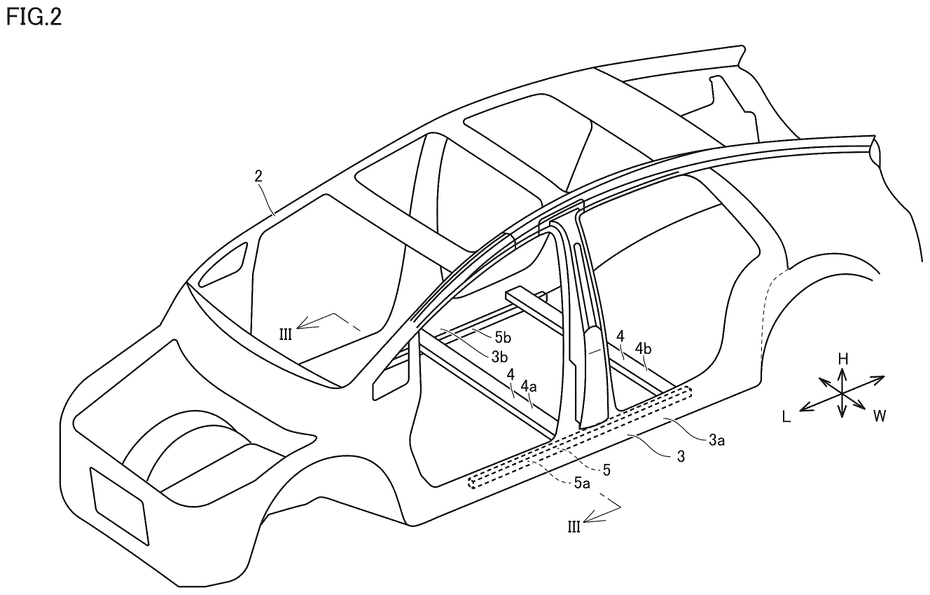

FIG. 2 is a perspective view schematically showing a vehicle frame of the vehicle 1. The vehicle frame 2 includes a side sill 3, a cross member 4, and a side member 5.

The side sill 3 extends in the stacking direction L. The side sill 3 includes a left side sill 3a and a right side sill 3b. The left side sill 3a and the right side sill 3b are disposed spaced apart from each other in the width direction W.

The cross member 4 extends in the width direction W. The cross member 4 couples the left side sill 3a and the right side sill 3b. The cross member 4 includes a front cross member 4a and a rear side member 4b. The front cross member 4a and the rear side member 4b are disposed spaced apart from each other in the stacking direction L.

The side member 5 extends in the stacking direction L. The side member 5 includes a left-side member 5a and a right-side member 5b.

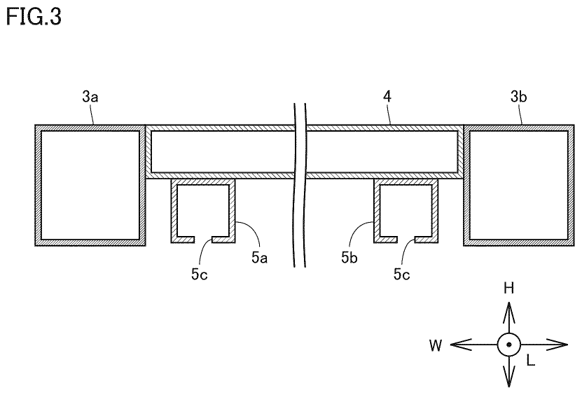

FIG. 3 shows a cross-sectional view of the vehicle 1 taken along a III-III cross section of FIG. 2. The left-side member 5a is disposed further inside the vehicle 1 than the left side sill 3a in the width direction W. The right-side member 5b is disposed further inside the vehicle 1 than the right side sill 3b in the width direction W.

The left-side member 5a and the right-side member 5b are supported by the cross member 4. More specifically, the upper surface of the left-side member 5a and the upper surface of the right-side member 5b are joined to the lower surface of the cross member 4. Screws for coupling the left-side member 5a and the right-side member 5b to the power storage device 10 pass through through-holes 5c formed in the lower surface of the left-side member 5a and the lower surface of the right-side member 5b.

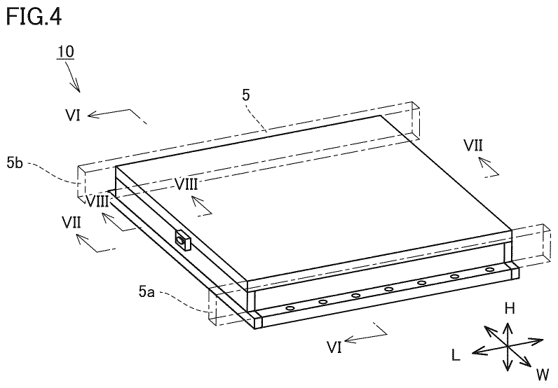

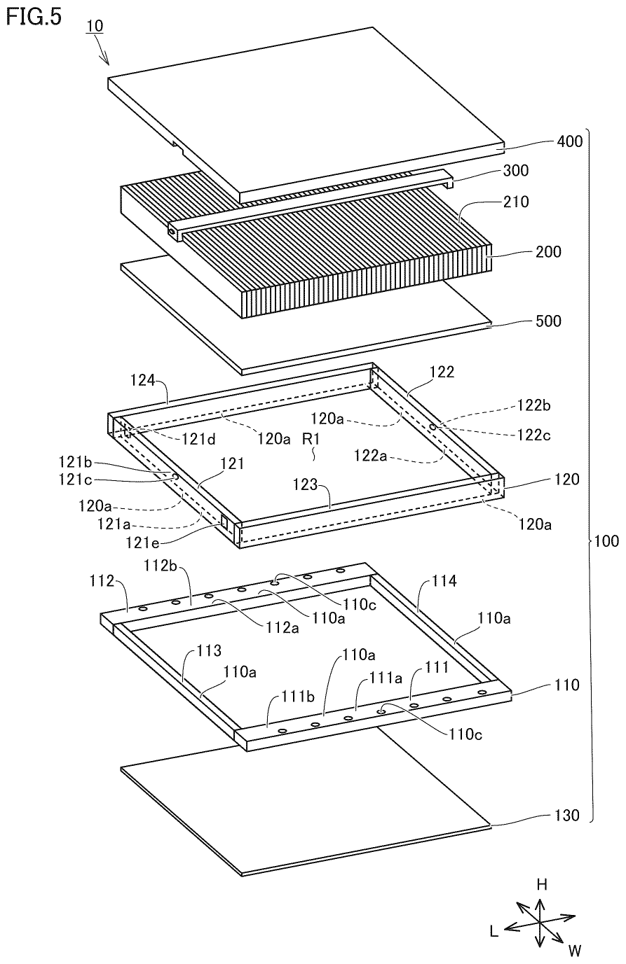

FIG. 4 is a perspective view schematically showing the power storage device 10. FIG. 5 is an exploded perspective view of the power storage device 10 of FIG. 4.

In FIG. 5, the power storage device 10 includes a housing case 100, a power storage module 200, a restraint 300, and a cooling device 500.

An accommodating space R1 for accommodating the power storage module 200 is formed in the housing case 100. The housing case 100 includes an upper cover 400, a base member 110, a surrounding wall 120, and a bottom plate 130.

The bottom plate 130 covers an opening in the base member 110.

The power storage module 200 is accommodated in the accommodating space R1 formed in the housing case 100. The power storage module 200 is formed of multiple power storage cells 210.

The power storage cells 210 are stacked in the stacking direction L. The power storage cell 210 is formed in a cuboid shape extending in the width direction W. One of the end surfaces of the power storage cell 210 in the width direction W reaches the inner wall of a side wall 123, and the other of the end surfaces reaches the inner wall of a side wall 124.

An electrode assembly and an electrolyte solution are accommodated in the power storage cell 210. As the power storage cell 210 charge or discharge power, the electrode assembly may expand and contract. As the electrode assembly expands, the power storage cell 210 expands in the stacking direction L. As a result, the power storage module 200 expands in the stacking direction L due to the cumulative effect of expansion of the power storage cells 210. Note that as the power storage cell 210 is internally shorted, hot gas may be produced within and exhausted out of the power storage cell 210.

The cooling device 500 covers the lower surface of the power storage module 200. The cooling device 500 and the power storage module 200 are accommodated in the housing case 100.

The upper cover 400 covers the entirety of the upper surface of the housing case 100.

The base member 110 is formed in a frame shape. A connecting zone 110a is formed on the base member 110 and faces the lower surface of the upper surface of the surrounding wall 120.

The base member 110 includes a side frame 111, a side frame 112, a front frame 113, and a rear frame 114.

The side frame 111 and the side frame 112 extend in the stacking direction L. The side frame 111 and the side frame 112 are disposed spaced apart from each other in the width direction W.

The front frame 113 and the rear frame 114 extend in the width direction. The front frame 113 and the rear frame 114 are provided spaced apart from each other in the stacking direction L.

The front frame 113 connects the front end portion of the side frame 111 and the front end portion of the side frame 112. The rear frame 114 connects the rear end portion of the side frame 111 and the rear end portion of the side frame 112.

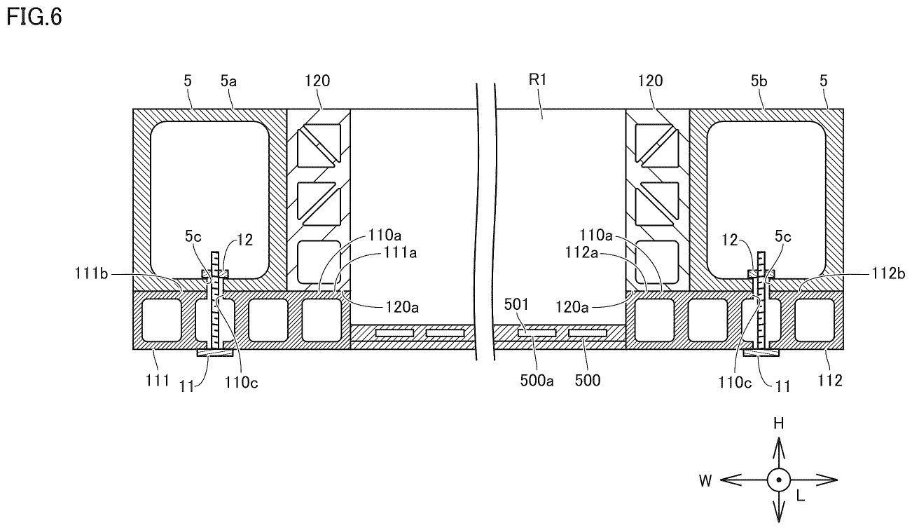

FIG. 6 is a cross-sectional view of the power storage device 10 taken along an IV-IV cross section of FIG. 4. In FIG. 6, the upper cover and the power storage module are not shown.

A first connecting region 111a and a second connecting region 111b are formed on the upper surface of the side frame 111. The first connecting region 111a faces a portion of a connecting section 120a which is the lower surface of the surrounding wall 120. The second connecting region 111b faces the lower surface of the left-side member 5a. Through-holes 110c are formed in the second connecting region 111b, passing therethrough in the up-down direction H. The first connecting region 111a and the second connecting region 111b are aligned in the width direction W.

A first connecting region 112a and a second connecting region 112b are formed on the upper surface of the side frame 112. The first connecting region 112a faces a portion of the connecting section 120a which is the lower surface of the surrounding wall 120. The second connecting region 112b faces the lower surface of the right-side member 5b. Through-holes 110c are formed in the second connecting region 112b, passing therethrough in the up-down direction H. The first connecting region 112a and the second connecting region 112b are aligned in the width direction W.

The first connecting region 111a and the first connecting region 112a are part of the components constituting the connecting zone 110a.

The power storage device 10 is fastened to the side member 5 with bolts 11 passing through the through-holes 110c of the power storage device 10 and the through-holes 5c of the side member 5, and nuts 12.

The cooling device 500 is disposed on the upper surface of the bottom plate 130 and the lower surface of the power storage module 200 not shown. A coolant route 500a is formed inside the cooling device 500. A coolant 501 flows through the coolant route 500a. This allows the cooling device 500 to cool the power storage module 200 from below.

Note that the lower surface of the bottom plate 130, on which the cooling device 500 is disposed, is flush with the lower surface of the base member 110.

Referring, again, to FIG. 5, the surrounding wall 120 is formed in a frame shape extending upward from the connecting zone 110a of the base member 110. The surrounding wall 120 has the connecting section 120a. The connecting section 120a is the lower surface of the surrounding wall 120. The connecting section 120a faces the connecting zone 110a of the base member 110.

The surrounding wall 120 is joined to the base member 110 at the connecting zone 110a of the base member 110 and the connecting section 120a of the surrounding wall 120.

The surrounding wall 120 includes a front wall 121, a rear wall 122, the side wall 123, and the side wall 124. Note that the front wall 121 is one example of a “first side wall” according to the present disclosure, the rear wall 122 is one example of a “second side wall” according to the present disclosure, the side wall 123 is one example of a “third side wall” according to the present disclosure, and the side wall 124 is one example of a “fourth side” wall according to the present disclosure.

The front wall 121 and the rear wall 122 extend in the width direction W. The front wall 121 and the rear wall 122 are disposed spaced apart from each other in the stacking direction L.

The front wall 121 connects the front end portion of the side wall 123 and the front end portion of the side wall 124. The rear wall 122 connects the rear end portion of the side wall 123 and the rear end portion of the side wall 124.

The side wall 123 and the side wall 124 extend in the stacking direction L. The side wall 123 and the side wall 124 are disposed spaced apart from each other in the width direction W.

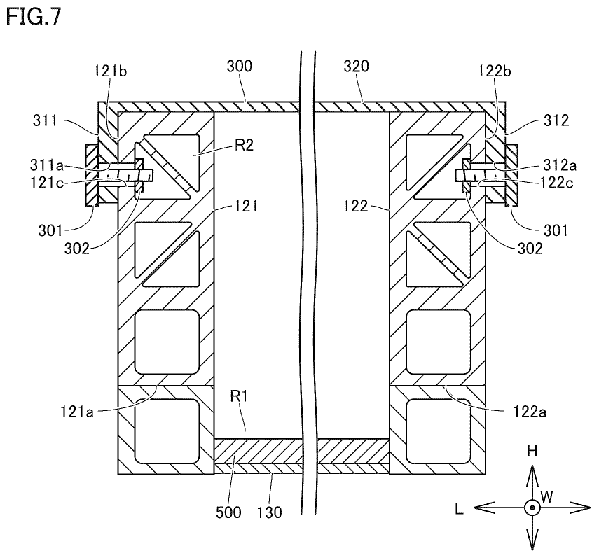

FIG. 7 is a cross-sectional view of the power storage device 10 taken along a VII-VII line of FIG. 4.

The front wall 121 has a first connecting portion 121a. The first connecting portion 121a is the lower surface of the front wall 121. The first connecting portion 121a forms a portion of the connecting section 120a.

The front wall 121 has a first restraining portion 121b. The first restraining portion 121b is a center portion of the outer wall of the front wall 121 in the width direction W. The first restraining portion 121b is an upper end portion of the front wall 121 or a portion located around it. The first restraining portion 121b is located spaced apart from the first connecting portion 121a in the up-down direction H. A through-hole 121c is formed in the first restraining portion 121b.

The rear wall 122 has a second connecting portion 122a. The second connecting portion 122a is the lower surface of the rear wall 122. The second connecting portion 122a forms a portion of the connecting section 120a.

The rear wall 122 further has a second restraining portion 122b. The second restraining portion 122b is disposed at the outer wall of the rear wall 122. The second restraining portion 122b is also a center portion of the outer wall of the rear wall 122 in the width direction W. The second restraining portion 122b is an upper end portion of the rear wall 122 or a portion located around it. The second restraining portion 122b is located spaced apart from the second connecting portion 122a in the up-down direction H. A through-hole 122c is formed in the second restraining portion 122b.

The restraint 300 includes a first restraint member 311, a second restraint member 312, and a coupling member 320.

The first restraint member 311 and the second restraint member 312 are arranged in the stacking direction L.

The first restraint member 311 passes through the top of the front wall 121, covering a side surface of the front wall 121. The first restraint member 311 covers the first restraining portion 121b.

A through-hole 311a is formed in the first restraint member 311, passing therethrough in the stacking direction L. The first restraint member 311 is restrained to the front wall 121 with a bolt 331 passing through the through-hole 311a and the through-hole 121c and a nut 332.

The second restraint member 312 passes through the top of the rear wall 122, covering a side surface of the rear wall 122. The second restraint member 312 covers the second restraining portion 122b.

A through-hole 312a is formed in the second restraint member 312. The second restraint member 312 is restrained to the rear wall 122 with a bolt 331 passing through the through-hole 312a and the through-hole 122c and a nut 332.

The coupling member 320 extends in the stacking direction L. The coupling member 320 couples the first restraint member 311 and the second restraint member 312.

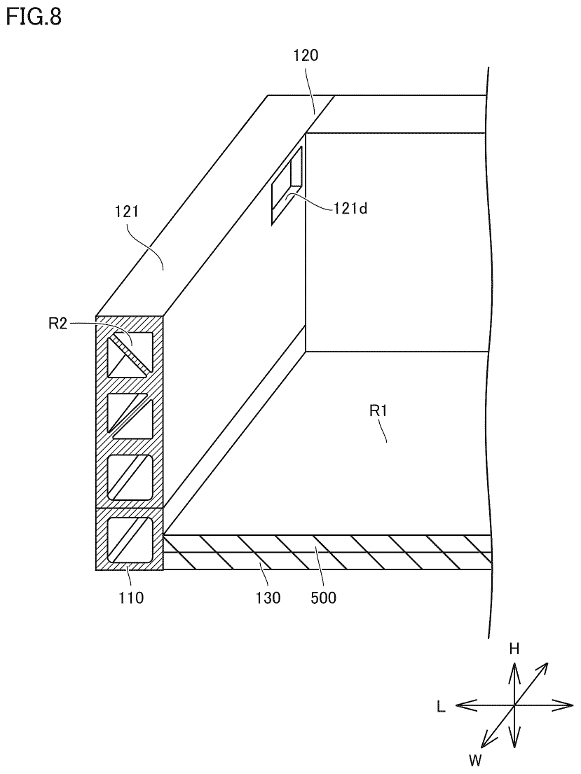

FIG. 8 is a cross-sectional view of the power storage device 10 taken along a VIII-VIII cross section of FIG. 4. In FIG. 8, the upper cover 400 and the power storage module 200 are not shown. A route R2 is formed inside the front wall 121. An opening 121d, open to the accommodating space R1, is formed in the inner wall surface of the front wall 121. An opening 121e, open externally, is formed in the outer wall surface of the front wall 121. The openings 121d and 121e are in communication with the route R2.

In the above embodiment, in the power storage device 10, the power storage module 200 expands in the stacking direction L by repeatedly charging and discharging power, which applies a load to the housing case 100. In FIG. 5, the restraint 300 restrains the first restraining portion 121b of the front wall 121 and the second restraining portion 122b of the rear wall 122. The front wall 121 and the rear wall 122 are disposed spaced apart from each other in the stacking direction L. The front wall 121 is joined to the front frame 113 at the first connecting portion 121a. The rear wall 122 is joined to the rear frame 114 at the second connecting portion 122a.

With this configuration, the power storage device 10 is provided, in which the surrounding wall 120 can be inhibited by not only the base member 110, but also the restraint 300, from being deformed in the stacking direction L due to the expansion of the power storage module 200.

Plus, in the power storage device 10 according to the present embodiment, the front wall 121 and the rear wall 122 function as the end plates of a conventional power storage device, and the conventional end plates are not used. In addition, the restraint 300 inhibits the front wall 121 and the rear wall 122 from being deformed. As such, the power storage device 10 can be provided, which inhibits the housing case 100 from being deformed in the stacking direction L, while reducing the part count.

In the above embodiment, the first restraining portion 121b is a center portion of the front wall 121 in the width direction W. The second restraining portion 122b is a center portion of the rear wall 122 in the width direction W. This allows the restraint 300 to be arranged to run through the center of the power storage cells 210 in the width direction W.

With this configuration, the restraint 300 can restrain the portion of the power storage module 200 that has the greatest amount of change upon the expansion. This can reduce the number of restraints 300, and the part count of the power storage device 10.

In the above embodiment, in the front wall 121, the route R2 is formed inside the front wall 121, the opening 121d that is open to the accommodating space R1 accommodating the power storage module 200 and in communication with the route R2 is formed, and the opening 121e that is open externally and in communication with the route R2 is formed.

With this configuration, the power storage device 10 can exhaust the gas, out of the power storage module 200, to the outside of the power storage device 10 via the route R2.

For example, the restraint 300 includes the restraining band connecting the front wall 121 and the dividing wall, and the restraining band connecting the dividing wall and the rear wall 122. As such, the restraint 300 may be formed of multiple restraining bands.

Note that, in such a power storage device, the restraint 300 can inhibit the power storage module 200 from being expanded and deformed in the stacking direction L.

In the above embodiment, the restraint 300 runs through the center of the cells. However, the present disclosure is not limited thereto. For example, a number of restraints 300 may be provided, besides the restraint 300 running through the center of the cells. A number of restraints 300 may be disposed equidistantly in the width direction.

In the above embodiment, the power storage device 10 is fastened to the side member 5. However, the present disclosure is not limited thereto. For example, the power storage device 10 may be mounted on the vehicle by being fastened to the cross member 4.

In the above embodiment, the vehicle 1 includes the power storage device 10 that is inhibited by the restraint 300 from being deformed, thereby reducing the load applied from the power storage device 10 to the side member 5. As a result, the vehicle frame 2 can be inhibited from being deformed.

In the above embodiment, the accommodating space R1 is formed in the housing case 100. However, the present disclosure is not limited thereto. For example, the housing case 100 may further include a dividing wall 170 dividing the accommodating space R1 into a first accommodating space R3 and a second accommodating space R4 arranged in the stacking direction L.

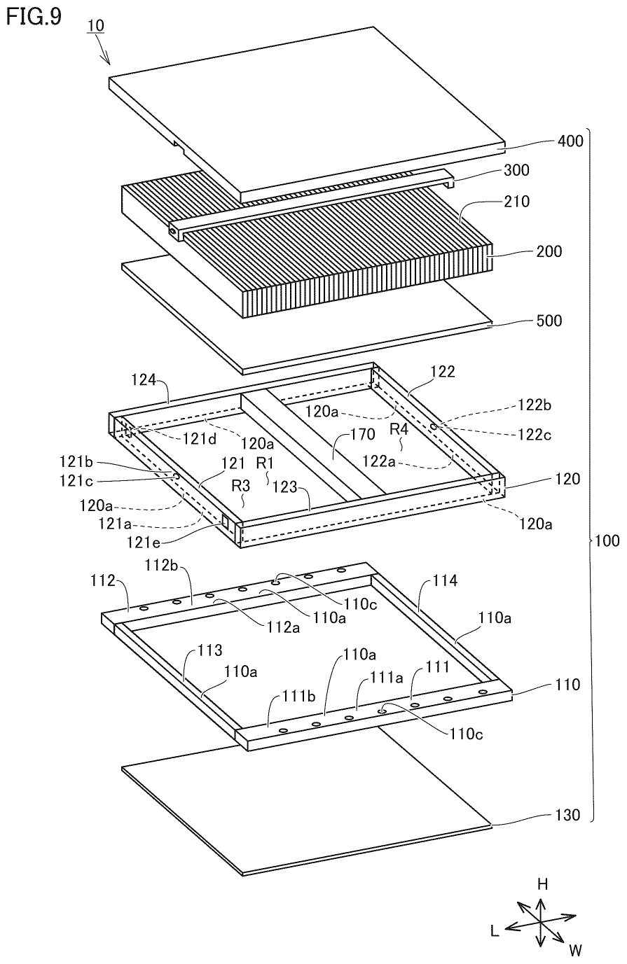

FIG. 9 shows an example in which the housing case 100 of the power storage device 10 according to the above embodiment further includes a dividing wall 170. The dividing wall 170 extends in the width direction W. One of the end surfaces of the dividing wall 170 in the width direction W reaches the inner wall of the side wall 123, and the other of the end surfaces reaches the inner wall of the side wall 124. The dividing wall 170 is arranged to run through the center of the surrounding wall 120 in the stacking direction L. In other words, the dividing wall 170 is arranged to run through the center of the side wall 123 and the center of the side wall 124. The dividing wall 170 divides the accommodating space R1 formed in the housing case 100 into the first accommodating space R3 and the second accommodating space R4.

### Variation 1

In the above embodiment, the connecting zone 110a is located on the upper surface of the base member 110, and the connecting section 120a is located on the lower surface of the surrounding wall 120. However, the present disclosure is not limited thereto. For example, the connecting zone 110a may be located on the inner surrounding wall of the base member 110, and the connecting section 120a may be located on the outer surrounding wall of the surrounding wall 120. Details are now described below.

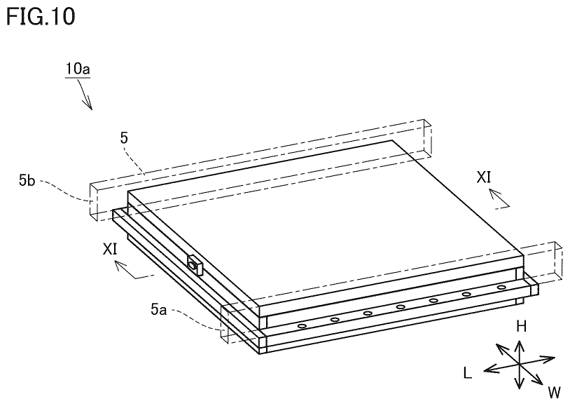

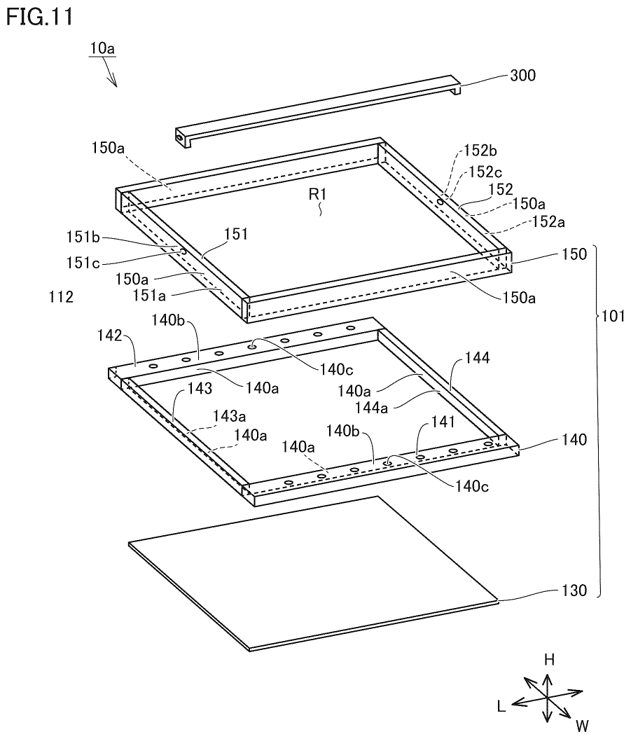

FIG. 10 is a schematic view of the power storage device according to Variation 1 of the present embodiment. FIG. 11 is an exploded perspective view of the power storage device according to Variation 1 of the present embodiment.

FIG. 11 shows a housing case 101 and the restraint 300, without showing the other components. Unless otherwise specified below, a power storage device 10a is the same as the power storage device 10 according to the embodiment of the present disclosure.

The housing case 101 includes a base member 140 and a surrounding wall 150.

The base member 140 is formed in a frame shape. The base member 140 includes a side frame 141, a side frame 142, a front frame 143, and a rear frame 144.

The side frame 141 and the side frame 142 extend in the stacking direction L. The side frame 141 and the side frame 142 are located spaced apart from each other in the width direction W.

The front frame 143 and the rear frame 144 extend in the width direction W. The front frame 143 and the rear frame 144 are located spaced apart from each other in the stacking direction L.

The front frame 143 connects the front end portion of the side frame 141 and the front end portion of the side frame 142. The rear frame 144 connects the rear end portion of the side frame 141 and the rear end portion of the side frame 142.

The base member 140 includes a first connecting region 140a and a second connecting region 140b.

The first connecting region 140a is the entire surface of the inner surrounding wall of the base member 140. The first connecting region 140a includes a first connecting region 143a and a first connecting region 144a.

The first connecting region 143a is formed on the entire surface of the inner wall of the front frame 143. The first connecting region 144a is formed on the entire surface of the inner wall of the rear frame 144.

The second connecting regions 140b are the upper surface of the side frame 141 and the upper surface of the side frame 142 and formed in a region of the side frame 141 and a region of the side frame 142 and face the lower surface of the side member 5.

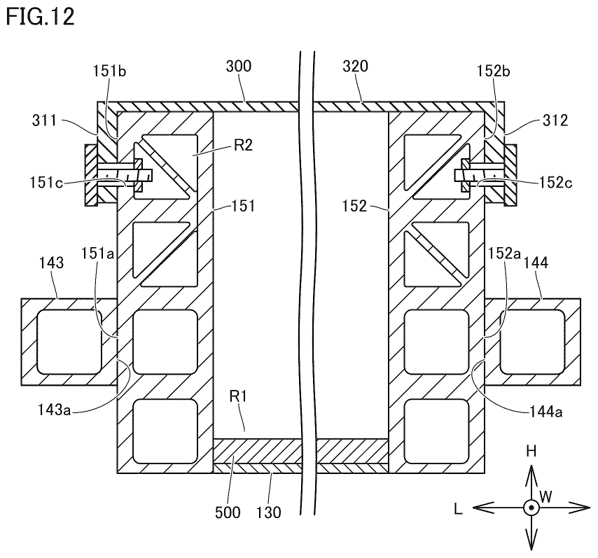

FIG. 12 is a cross-sectional view of the power storage device 10b taken along an XI-XI cross section of FIG. 10. In FIG. 12, the power storage module 200 and the upper cover 400 are not shown.

The surrounding wall 150 is formed in a frame shape. The surrounding wall 150 includes a front wall 151 and a rear wall 152. The front wall 151 and the rear wall 152 extend in the width direction W. The front wall 151 and the rear wall 152 are located spaced apart from each other in the stacking direction L.

The surrounding wall 150 further has a connecting section 150a. The connecting section 150a is the outer wall of the surrounding wall 150. The connecting section 150a has a first connecting portion 151a and a second connecting portion 152a.

The front wall 151 has a first connecting portion 151a and a first restraining portion 151b.

The first connecting portion 151a is a region of the outer wall of the front wall 151, facing the first connecting region 143a.

The first restraining portion 151b is a center portion of the outer wall of the front wall 151 in the width direction W. The first restraining portion 151b is an upper end portion of the front wall 151 and a portion located around it. The first restraining portion 151b is located spaced apart from the first connecting portion 151a in the up-down direction H. A through-hole 151c is formed in the first restraining portion 151b.

The rear wall 152 has a second connecting portion 152a and a second restraining portion 152b.

The second connecting portion 152a is a region of the outer wall of the rear wall 152, facing the first connecting region 144a.

The second restraining portion 152b is a center portion of the outer wall of the rear wall 152 in the width direction W. The second restraining portion 152b is an upper end portion of the front wall 151 and a portion located around it. The second restraining portion 152b is located spaced apart from the second connecting portion 152a in the up-down direction H. The through-hole 152c is formed in the second restraining portion 152b.

Note that the first connecting portion 151a and the second connecting portion 152a form a part of the connecting section 150a.

As noted above, in Variation 1 according to the embodiment, the surrounding wall 150 is joined to the base member 140 so that the first connecting region 140a and the connecting section 150a are in contact.

### Variation 2

In the above embodiment, the stacking direction L coincides with the front-rear direction of the vehicle. However, the present disclosure is not limited thereto. For example, the stacking direction L may coincide with the width direction. Details are now described below.

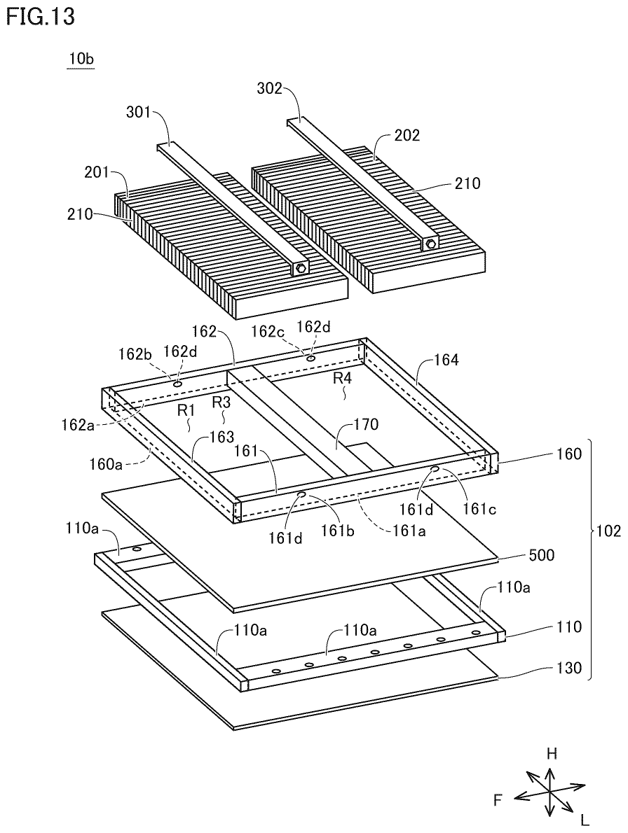

FIG. 13 is a schematic view of a power storage device according to Variation 2 of the present embodiment. In FIG. 13, the upper cover 400 is not shown. Unless otherwise specified below, a power storage device 10b is the same as the power storage device 10 according to the present disclosure.

Here, in FIG. 13, a front-rear direction F indicates the front-rear direction of the vehicle, and the stacking direction L indicates the direction in which the power storage cells are stacked. Note that, in Variation 2, the stacking direction L coincides with the width direction of the vehicle and is one example of the “first direction” according to the present disclosure. The front-rear direction Fis one example of the “second direction” according to the present disclosure.

The power storage device 10b includes a housing case 102, power storage modules 201 and 202, and restraints 301 and 302.

The housing case 102 accommodates the power storage module 201 and the power storage module 202 in the first accommodating space R3 and the second accommodating space R4. The housing case includes a base member 110, a surrounding wall 160, and a dividing wall 170.

The surrounding wall 160 is formed in a frame shape extending upward from the connecting zone 110a of the base member 110. The surrounding wall 160 has a connecting section 160a. The connecting section 160a is the lower surface of the surrounding wall 160, facing the connecting zone 110a. The surrounding wall 160 is joined to the base member 110 at the connecting zone 110a of the base member 110 and the connecting section 160a of the surrounding wall 160.

The surrounding wall 160 includes a side wall 161, a side wall 162, a front wall 163, and a rear wall 164. Note that, in Variation 2, the side wall 161 is one example of the “first side wall” according to the present disclosure, the side wall 162 is one example of the “second side wall” according to the present disclosure, the front wall 163 is one example of the “third side wall” according to the present disclosure, and the rear wall 164 is one example of a “fourth side wall” according to the present disclosure.

The side wall 161 and the side wall 162 extend in the front-rear direction F. The side wall 161 and the side wall 162 are located spaced apart from each other in the stacking direction L.

The front wall 163 and the rear wall 164 extend in the stacking direction L. The front wall 163 and the rear wall 164 are located spaced apart from each other in the stacking direction L.

The front wall 163 connects the front end portion of the side wall 161 and the front end portion of the side wall 162. The rear wall 164 connects the rear end portion of the side wall 161 and the rear end portion of the side wall 162.

The dividing wall 170 extends in the stacking direction L. One of the end surfaces of the dividing wall 170 in the stacking direction L reaches the inner wall of the side wall 161, and the other of the end surfaces reaches the inner wall of the side wall 162. The dividing wall 170 is arranged to run through the center of the surrounding wall 160 in the front-rear direction F. In other words, the dividing wall 170 is arranged to run through the center of the side wall 161 and the center of the side wall 162. The dividing wall 170 divides the accommodating space R1 formed in the housing case 100 into a first accommodating space and a second accommodating space. The dividing wall 170 divides the housing case 102 into the first accommodating space R3 and the second accommodating space R4.

The side wall 161 has a first connecting portion 161a and first restraining portions 161b and 161c.

The first connecting portion 161a is the lower surface of the side wall 161. The first connecting portion 161a forms a portion of the connecting section 160a.

The first restraining portion 161b is a center portion of the outer wall of the side wall 161 in the front-rear direction F between the front wall 163 and the dividing wall 170. The first restraining portion 161c is a center portion of the outer wall of the side wall 161 in the front-rear direction F between the dividing wall 170 and the rear wall 164. The first restraining portions 161b and 161c are located spaced apart from the first connecting portion 161a in the up-down direction H. Through-holes 161d are formed in the first restraining portions 161b and 161c.

The side wall 162 has a first connecting portion 162a and first restraining portions 162b and 162c.

The first connecting portion 162a is the lower surface of the side wall 162. The first connecting portion 162a forms a portion of the connecting section 160a.

The first restraining portion 162b is a center portion of the outer wall of the side wall 162 between the front wall 163 and the dividing wall 170 in the front-rear direction F. The first restraining portion 162c is a center portion of the outer wall of the side wall 161 between the dividing wall 170 and the rear wall 164 in the front-rear direction F. The first restraining portions 162b and 162c are located spaced apart from the first connecting portion 162a in the up-down direction H. Through-holes 162d are formed in the first restraining portions 162b and 162c.

The power storage modules 201 and 202 are accommodated in the first accommodating space R3 and the second accommodating space R4 formed in the housing case 102. The power storage modules 201 and 202 are formed of multiple power storage cells 210.

The plurality of power storage cells 210 are stacked in the stacking direction L. The power storage cell 210 is formed in a cuboid shape extending in the front-rear direction F.

The restraints 301 and 302 extend in the stacking direction L. The restraint 301 extends from the first restraining portion 161b of the side wall 161 to the first restraining portion 162b of the side wall 162. The restraint 302 bridges the first restraining portion 161c of the side wall 161 and the first restraining portion 162c of the side wall 162.

In Variation 2 above, the restraint 301 connects the first restraining portion 161b and the first restraining portion 162b. With this configuration, the restraint 301 is arranged to run through the center, in the front-rear direction F, of power storage cells 210, forming the power storage module 201. Similarly, the restraint 302 is arranged to run through the center, in the front-rear direction F, of power storage cells 210, forming the power storage module 202.

With this configuration, the restraints 301 and 302 can restrain the portions of the power storage modules 201 and 202 that have greatest amounts of change upon the expansion. This can reduce the number of restraints 301 and 302, and the part count of the power storage device 10.

In Variation 2 above, the dividing wall 170 divides the housing case 102 into the first accommodating space R3 and the second accommodating space R4. However, the present disclosure is not limited thereto. For example, the housing case 102 may not have the dividing wall 170. In this case, the accommodating space R1 is formed in the housing case 102. The power storage module 200 accommodated in the accommodating space R1 includes the power storage cells 210 that are arranged in the stacking direction L and extend in the front-rear direction F. One of the end surfaces of the power storage cell 210 in reaches the inner wall of the front wall 163, and the other of the end surfaces reaches the inner wall of the rear wall 164.

While the embodiments according to the present disclosure has been described above, the presently disclosed embodiments should be considered in all aspects illustrative and not restrictive. The scope of the present disclosure is defined by the appended claims. All changes which come within the meaning and range of equivalency of the appended claims are to be embraced within their scope.

What is claimed is:

1. A power storage device, comprising:
a power storage module; a housing case in which an accommodating space is formed; and a restraint, wherein
the power storage module is accommodated in the accommodating space,
the housing case includes: a base member; a first side wall connected to the base member; and a second side wall connected to the base member and disposed spaced apart from the first side wall in a first direction,
the first side wall includes: a first connecting portion connected to the base member; and a first restraining portion located spaced apart from the first connecting portion in an up-down direction,
the second side wall includes: a second connecting portion connected to the base member; and a second restraining portion located spaced apart from the second connecting portion in the up-down direction, and
the restraint is formed to restrain the first restraining portion and the second restraining portion.

2. The power storage device according to claim 1, wherein
the power storage module includes a plurality of power storage cells arranged in the first direction,
the plurality of power storage cells are each formed to extend in a second direction intersecting with the first direction, and
the restraint is arranged to run through a center of the plurality of power storage cells in the second direction.

3. The power storage device according to claim 2, wherein
an opening open to the accommodating space is formed in the first side wall, and a route is formed in the first side wall and in communication with the opening.

4. The power storage device according to claim 3, wherein
the housing case further includes a dividing wall,
the accommodating space has a first accommodating space and a second accommodating space, and
the dividing wall is formed to extend in the first direction and disposed between a center of the first side wall in the second direction and a center of the second side wall in the second direction to define the first accommodating space and the second accommodating space.

5. The power storage device according to claim 3, wherein
the housing case further includes: a third side wall connected to the base member; a fourth side wall connected to the base member and disposed spaced apart from the third side wall in the second direction; and a dividing wall,
the accommodating space has a first accommodating space and a second accommodating space, and
the dividing wall is formed to extend in the second direction and disposed between a center of the third side wall in the first direction and a center of the fourth side wall in the first direction to define the first accommodating space and the second accommodating space.

6. The power storage device according to claim 1, wherein
the power storage module includes a plurality of power storage cells arranged in the first direction,
the plurality of power storage cells are each formed to extend in a second direction intersecting with the first direction,
the first side wall and the second side wall are disposed spaced apart from each other in the first direction,
the housing case further includes: a third side wall connected to the base member; and a fourth side wall connected to the base member and disposed spaced apart from the third side wall in the second direction, and
the plurality of power storage cells are each disposed from the third side wall to the fourth side wall.

7. A vehicle, comprising:
a vehicle body; and
a power storage device according to claim 2, the power storage device being mounted on the vehicle body, wherein
the first direction is a front-rear direction of the vehicle.

8. A vehicle, comprising:
a vehicle body; and
the power storage device according to claim 3, the power storage device being mounted on the vehicle body, wherein
the first direction is a front-rear direction of the vehicle.

9. A vehicle, comprising:
a vehicle body; and
the power storage device according to claim 5, the power storage device being mounted on the vehicle body, wherein
the first direction is a front-rear direction of the vehicle.

10. A vehicle, comprising:
a vehicle body; and
the power storage device according to claim 6, the power storage device being mounted on the vehicle body, wherein
the first direction is a front-rear direction of the vehicle.

11. A vehicle, comprising:
a vehicle body; and
the power storage device according to claim 2, the power storage device being mounted on the vehicle body, wherein
the first direction is a width direction of the vehicle.

12. A vehicle, comprising:
a vehicle body; and
the power storage device according to claim 3, the power storage device being mounted on the vehicle body, wherein
the first direction is a width direction of the vehicle.

13. A vehicle, comprising:
a vehicle body; and
the power storage device according to claim 4, the power storage device being mounted on the vehicle body, wherein
the first direction is a width direction of the vehicle.

14. A vehicle, comprising:
a vehicle body; and
the power storage device according to claim 6, the power storage device being mounted on the vehicle body, wherein
the first direction is a width direction of the vehicle.
